(19) United States
(12) Patent Application Publication
(10) Pub. No.: US 2025/0182753 A1
(43) Pub. Date: Jun. 5, 2025

(54) NON-AUTOREGRESSIVE AND MULTILINGUAL LANGUAGE-MODEL-FUSED ASR SYSTEM

(71) Applicant: Google LLC, Mountain View, CA (US)

(72) Inventors: Wenqian Ronny Huang, Mountain View, CA (US); Cyril Allauzen, Mountain View, CA (US); Tongzhou Chen, Sunnyvale, CA (US); Shuo-yiin Chang, Sunnyvale, CA (US); Tara N. Sainath, Jersey City, NJ (US)

(73) Assignee: Google LLC, Mountain View, CA (US)

(21) Appl. No.: 18/939,443

(22) Filed: Nov. 6, 2024

Related U.S. Application Data
(60) Provisional application No. 63/605,460, filed on Dec. 1, 2023.

(51) Int. Cl. G10L 15/197; G10L 15/00; G10L 15/16

(52) U.S. Cl. CPC G10L 15/197; G10L 15/005; G10L 15/16

(57) ABSTRACT

A method includes, for each respective audio segment in a series of audio segments: generating, using a speech recognition model, multiple candidate speech recognition hypotheses for the respective audio segment and concatenating each respective candidate speech recognition hypothesis from the multiple candidate speech recognition hypotheses with a previously generated transcription corresponding to N prior audio segments. Each respective candidate speech recognition hypothesis includes a corresponding probability. For each respective audio segment, the method also includes rescoring, using a large language model (LLM), the corresponding probability of each respective candidate speech recognition hypothesis based on the concatenation and generating a transcription of the respective speech segment by selecting a respective one of the candidate speech recognition hypotheses that includes a highest rescored probability.

### CROSS-REFERENCE TO RELATED APPLICATIONS

This U.S. patent application claims priority under 35 U.S.C. § 119(e) to U.S. Provisional Application 63/605,460, filed on Dec. 1, 2023. The disclosure of this prior application is considered part of the disclosure of this application and is hereby incorporated by reference in its entirety.

### TECHNICAL FIELD

This disclosure relates to a non-autoregressive and multilingual language-model-fused automated speech recognition (ASR) system.

### BACKGROUND

Automatic speech recognition (ASR) systems have increased in popularity in recent years for assistant enabled devices. Improving recognition performance of words is an ongoing problem for ASR systems. This problem is further complicated for words that are infrequently spoken. That is, words that are infrequently spoken are rarely included in training data and, therefore, are difficult for ASR systems to accurately recognize in speech. In some instances, ASR systems include language models that train on text-only data to improve recognition of infrequently spoken words. Yet, using these language models oftentimes increases latency and requires large amounts of memory and computational resources such that integration of language models for many applications is unsuitable.

### SUMMARY

One aspect of the disclosure provides a computer-implemented method that when executed on data processing hardware causes the data processing hardware to perform operations that include receiving a series of audio segments corresponding to speech spoken by a user and for each respective audio segment in the series of audio segments, generating, using a speech recognition model, multiple candidate speech recognition hypotheses for the respective audio segment and concatenating each respective candidate speech recognition hypothesis from the multiple candidate speech recognition hypotheses with a previously generated transcription corresponding to N prior audio segments. Each respective candidate speech recognition hypothesis includes a corresponding probability. For each respective audio segment in the series of audio segments, the operations also include rescoring, using a large language model (LLM), the corresponding probability of each respective candidate speech recognition hypothesis based on the concatenation of the respective candidate speech recognition hypothesis and the previously generated transcription, and generating a transcription of the respective speech segment by selecting a respective one of the candidate speech recognition hypotheses comprising a highest rescored probability.

Implementations of the disclosure may include one or more of the following optional features. In some implementations, the speech recognition model includes an encoder and a decoder. Here, the encoder may generate a higher order feature representation for each respective audio segment by applying chunk-wise bi-directional attention. Additionally, the encoder may include a stack of multi-headed attention layers each including a multi-headed self-attention mechanism. Here, the stack of multi-headed attention layers may include a stack of conformer layers. The stack of conformer layers may include a stack of 32 layers having about two billion parameters. Moreover, the decoder may include a Connectionist Temporal Classification (CTC) decoder. In these implementations, the decoder may generate the multiple candidate speech recognition hypotheses non-autoregressively and the LLM may rescore the corresponding probability of each respective candidate speech recognition hypothesis non-autoregressively.

In some examples, the speech spoken by the user includes a long-form utterance. In some additional examples, the N prior audio segments immediately precede the respective audio segment.

Another aspect of the present disclosure provides a system that includes data processing hardware and memory hardware storing instructions that when executed on the data processing hardware causes the data processing hardware to perform operations that include receiving a series of audio segments corresponding to speech spoken by a user and for each respective audio segment in the series of audio segments, generating, using a speech recognition model, multiple candidate speech recognition hypotheses for the respective audio segment and concatenating each respective candidate speech recognition hypothesis from the multiple candidate speech recognition hypotheses with a previously generated transcription corresponding to N prior audio segments. Each respective candidate speech recognition hypothesis includes a corresponding probability. For each respective audio segment in the series of audio segments, the operations also include rescoring, using a large language model (LLM), the corresponding probability of each respective candidate speech recognition hypothesis based on the concatenation of the respective candidate speech recognition hypothesis and the previously generated transcription, and generating a transcription of the respective speech segment by selecting a respective one of the candidate speech recognition hypotheses comprising a highest rescored probability.

This aspect of the disclosure may include one or more of the following optional features. In some implementations, the speech recognition model includes an encoder and a decoder. Here, the encoder may generate a higher order feature representation for each respective audio segment by applying chunk-wise bi-directional attention. Additionally, the encoder may include a stack of multi-headed attention layers each including a multi-headed self-attention mechanism. Here, the stack of multi-headed attention layers may include a stack of conformer layers. The stack of conformer layers may include a stack of 32 layers having about two billion parameters. Moreover, the decoder may include a Connectionist Temporal Classification (CTC) decoder. In these implementations, the decoder may generate the multiple candidate speech recognition hypotheses non-autoregressively and the LLM may rescore the corresponding probability of each respective candidate speech recognition hypothesis non-autoregressively.

In some examples, the speech spoken by the user includes a long-form utterance. In some additional examples, the N prior audio segments immediately precede the respective audio segment.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system implementing a speech recognition system.

FIG. 2 is a schematic view of an example speech recognition system.

FIG. 3 is a schematic view of an example computing device that may be used to implement the systems and methods described herein.

FIG. 4 is a flowchart of an exemplary arrangement of operations for a method of using non-autoregressive and multilingual language models for rescoring speech recognition results output from a non-autoregressive speech recognition model.

Like reference symbols in the various drawings indicate like elements.

### DETAILED DESCRIPTION

Large-scale speech models, such as multilingual automatic speech recognition (ASR) models and multilingual large language models (LLMs), have recently shown significant performance (e.g., word error rate (WER) and latency) improvements. Many speech applications (e.g., voice assistants and live captioning) have strict latency constraints such that integrating these large-scale ASR models and LLMs together is impractical. For instance, the autoregressive operating nature (e.g., generating each output sequentially based on context of one or more prior input frames) of these models leads to significant latency increases such that integration is not practical for applications with strict latency constraints. On the other hand, the large model size of the large-scale ASR models and LLMs makes integration of these models unsuitable for mobile applications with computational and/or memory constraints.

To that end, implementations herein are directed towards methods and systems of using non-autoregressive and multilingual language models for rescoring speech recognition results output from a non-autoregressive speech recognition model. In particular, the method includes receiving a series of audio segments corresponding to speech spoken by a user. For each respective audio segment, the method includes generating, using a speech recognition model, multiple candidate speech recognition hypotheses each including a corresponding probability, concatenating each respective candidate speech recognition hypothesis with a previously generated transcription corresponding to N prior audio segments, rescoring the corresponding probability of each respective candidate speech recognition hypothesis based on the concatenation using a large language model (LLM), and generating a transcription of the respective speech segment by selecting a respective one of the candidate speech recognition hypotheses comprising a highest rescored probability. Notably, the speech recognition model and the LLM operate non-autoregressively. That is, the speech recognition model and the LLM generate all outputs for each respective audio segment in parallel instead of operating sequentially. Advantageously, by rescoring the multiple candidate speech recognition hypotheses using the LLM, transcription accuracy significantly increases while operating at minimal latency due to the non-autoregressive operation of the speech recognition model and the LLM. Moreover, generating transcriptions for each audio segment that includes one or more acoustic frames is more efficient than generating transcriptions for each acoustic frame (i.e., shallow fusion).

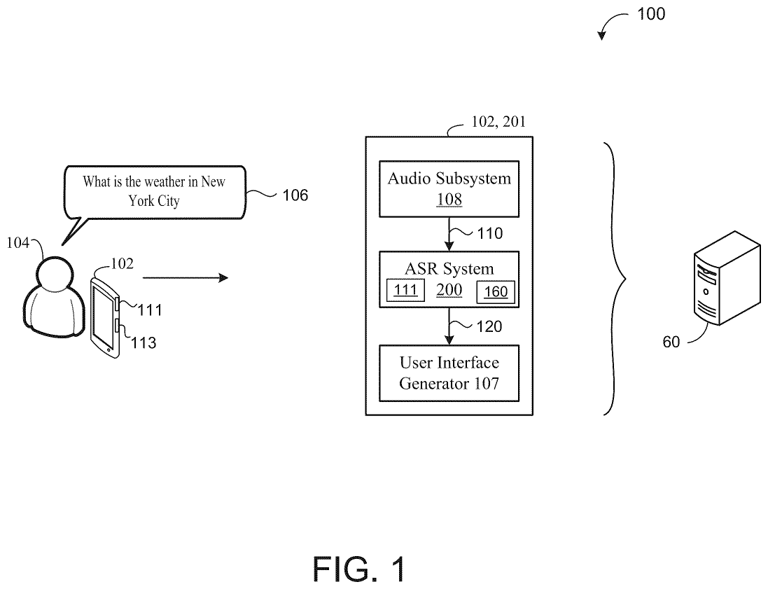

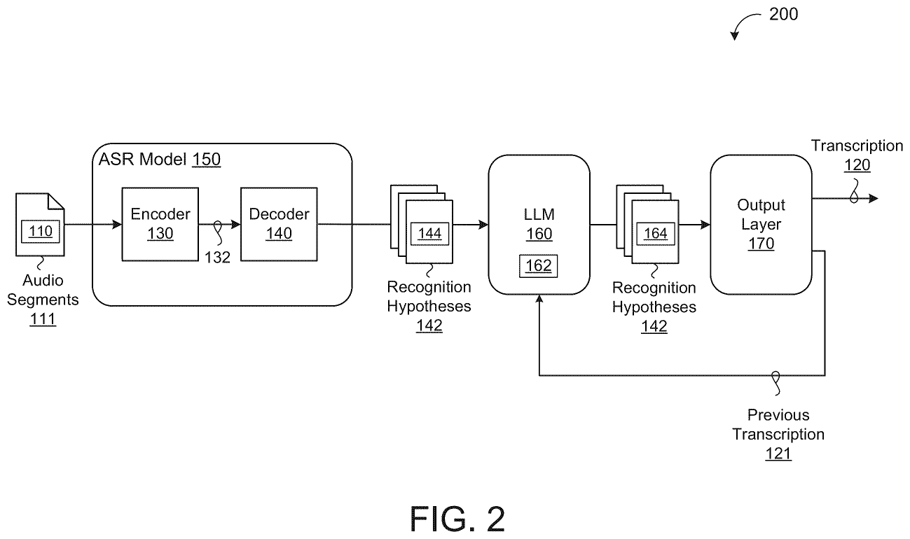

FIG. 1 illustrates a system 100 that includes a user 104 interacting with a user device 102 in communication with a remote computing device 201. The system 100 includes an automated speech recognition (ASR) system 200 implementing an ASR model 150 (FIG. 2) and a large language model (LLM) 160 (FIG. 2) that reside on the user device 102 and/or on a remote computing device 201 (e.g., one or more servers of a distributed system executing in a cloud-computing environment). Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart/speaker display, a smart appliance, an automotive infotainment system, or an Internet-of-Things (IoT) device, and is equipped with data processing hardware and memory hardware 113.

The user device 102 includes an audio subsystem 108 configured to receive an utterance spoken by the user 104 (e.g., the user device 102 may include one or more microphones for recording the spoken utterance 106) and convert the utterance 106 into a corresponding digital format associated with input acoustic frames (i.e., audio features) 110 capable of being processed by the ASR system 200. In the example shown, the user 104 speaks a respective utterance 106 in a natural language of English for the phrase “What is the weather in New York City?” and the audio subsystem 108 converts the utterance 106 into corresponding acoustic frames 110 for input to the ASR system 200. Thereafter, the ASR model 150 receives, as input, the acoustic frames 110 corresponding to the utterance 106, and generates/predicts, as output, a corresponding transcription 120 (e.g., recognition result/hypothesis) of the utterance 106. In some examples, the ASR system 200 segments the sequence of acoustic frames 110 into a series of audio segments 111 each including one or more of the acoustic frames 110. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 200 is processed, e.g., by the LLM 160 having natural language understanding (NLU) capabilities to execute a user command. Additionally or alternatively, a text-to-speech system (e.g., executing on any combination of the user device 102 or the remote computing device 201) may convert the transcription 120 into synthesized speech for audible output by another device. For instance, the original utterance 106 may correspond to a message the user 104 is sending to a friend in which the transcription 120 is converted to synthesized speech for audible output to the friend to listen to the message conveyed in the original utterance.

Referring to FIG. 2, the ASR system 200 includes the ASR model 150, the LLM 160, and an output layer 170. The ASR system 200 may operate non-autoregressively on a per-segment basis whereby the ASR system 200 generates a corresponding transcription 120 for each respective audio segment 111 in the series of audio segments 111. That is, instead of generating a corresponding transcription 120 for each acoustic frame 110 in the sequence of acoustic frames 110 (e.g., operating on a per-frame basis), the ASR system 200 processes the acoustic frames 110 from each audio segment 111 and generates a corresponding transcription 120 for each respective audio segment 111. As such, the ASR system 200 may segment the sequence of acoustic frames 110 characterizing a spoken utterance (e.g., speech spoken by one or more users) into a series of audio segments 111. The speech spoken by the one or more users may include a long-form utterance including minutes or hours of speech. For instance, the long-form utterance may include 15 minutes of speech input from a video for a video captioning application.

In some implementations, the ASR system 200 segments the sequence of acoustic frames 110 into one or more fixed-length audio segments 111 each including a fixed number of the acoustic frames 110. For example, the ASR system 200 may segment a respective sequence of acoustic frames 110 that includes 30 seconds of audio into four (4) audio segments 111 each including eight (8) seconds of audio. In this example, the last audio segment 111 includes six (6) seconds of audio and may be padded with an additional 2 seconds of blank acoustic frames. Continuing with the example, the ASR system 200 processes each respective 8 second audio segment 111 to generate a corresponding transcription 120 for each respective audio segment 111. Moreover, the ASR system 200 operates in a streaming manner such that, after processing each respective audio segment 111, the ASR system 200 outputs a corresponding transcription 120. That is, the ASR system 200 may output a corresponding transcription 120 every 8 seconds when the series of audio segments 111 each include 8 seconds of audio data.

The ASR model 150 may be a Universal Speech Model (USM) that is trained on multilingual training data that includes over 12 million hours of unlabeled audio, 28 billion sentences of text data, 110 thousand hours of supervised, and/or 100 thousand hours of semi-supervised audio data. The ASR model 150 includes an encoder 130 and a decoder 140. In some examples, the encoder 130 has a stack of multi-headed attention layers. For instance, the stack of multi-headed attention layers (e.g., 32 layers) may include a stack of conformer layers or transformer layers. The encoder 130 is configured to receive, as input, the series of audio segments 111 and generate, at each of a plurality of output steps, a higher order feature representation 132 for a corresponding audio segment 111 from the series of audio segments 111. The higher order feature representation 132 includes a series of encodings representing the acoustic frames 110 from the audio segment 111. In some implementations, the encoder 130 generates the higher order feature representation 132 by applying chunk-wise bi-directional attention. In particular, the encoder 130 performs chunk-wise bi-directional attention by performing attention on each audio segment 111 (i.e., chunk). In contrast to block processing, which forces all encoder layers to process the context frame associated with a current chunk, chunk-wise bi-directional attention is more flexible by allowing other layers of the encoder 130 to process contextual frames beyond the current chunk.

The decoder 140 of the ASR model 150 is configured to receive, as input, the higher order feature representation 132 generated by the encoder 130 at each output step and generate, at each of the plurality of output steps, multiple candidate speech recognition hypothesis 142 for a corresponding higher order feature representation 132. Each respective candidate speech recognition hypothesis 142 of the multiple candidate speech recognition hypotheses 142 includes a corresponding probability 144 indicating a likelihood that the respective candidate speech recognition hypothesis 142 is an accurate transcription of the speech from the corresponding audio segment 111. Thus, the multiple candidate speech recognition hypotheses 142 output by the decoder 140 may include a probability distribution 144 over the multiple candidate speech recognition hypotheses 142. The multiple candidate speech recognition hypotheses 142 correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the probability distribution 144 may indicate a likelihood of occurrence of each of a predetermined set of output labels. In some configurations, the output labels are graphemes (e.g., individual characters, and potentially punctuation and other symbols), but the set of output labels is not so limited. For example, the set of output labels can include wordpieces and/or entire words, in addition to or instead of graphemes. The probability distribution 144 can include a posterior probability value for each of the different output labels. Thus, if there are 100 different output labels representing different graphemes or other symbols, the probability distribution 144 can include 100 different probability values, one for each output label. The probability distribution 144 can then be used by the output layer 170 to select and assign scores to candidate orthographic elements (e.g., graphemes, wordpieces, and/or words) in a beam search process for determining the transcription 120.

In some examples, the decoder 140 includes a Connectionist Temporal Classification (CTC) decoder that operates non-autoregressively. That is, each higher order feature representation 132 generated by the encoder 130 may include a sequence of encodings such that each encoding in the sequence of encodings represents a respective one of the acoustic frames 110 from the corresponding audio segment 111. As such, the decoder 140 operates in parallel (e.g., non-autoregressively) by generating a respective candidate speech recognition hypothesis 142 for each acoustic frame 110 from the respective audio segment 111 at the same time. Since the decoder 140 operates in parallel, the decoder 140 generates the respective candidate speech recognition hypothesis 142 for each acoustic frame 110 from the respective audio segment 111 independently from each other acoustic frame 110 of the respective audio segment 111. Stated differently, generating each candidate speech recognition hypothesis 142 is not dependent upon any of the other acoustic frames 110 from the respective audio segment 111.

For example, the decoder 140 may process a respective higher order feature representation 212 generated from an 8 second audio segment 111 that has 8 acoustic frames 110 (e.g., 8 separate 1 second acoustic frames 110) to generate 8 corresponding probability distributions 144 over candidate speech recognition hypotheses 142. Here, each probability distribution 144 over candidate speech recognition hypotheses 142 corresponds to a recognition result for a corresponding one of the 1 second acoustic frames 110. Thus, in this example, the multiple candidate speech recognition hypotheses 142 output by the decoder 140 may include each possible path that traverses each of the 8 corresponding probability distributions 144 over candidate speech recognition hypotheses 142. All of the possible paths form a confusion network lattice that grows exponentially as the length of the audio segment 111 increases thereby making it challenging for the LLM to rescore each of the candidate speech recognition hypotheses. To that end, the ASR model 150 operates on fixed-length audio segments (e.g., 8 seconds) to limit rescoring complexity. In some implementations, the decoder 140 may sum the corresponding probability 144 of each candidate speech recognition hypothesis 142 for each possible path and output the N-best list of candidate speech recognition hypotheses 142 having the highest summed probability. In contrast to the CTC decoder architecture, other speech recognition architectures, such as Recurrent Neural Network-Transducer (RNN-T) architectures, process each frame sequentially (e.g., generate one output at a time) whereby the output for each frame is dependent upon one or more previous frames causing increased latency.

The ASR system 200 employs the LLM 160 to rescore the corresponding probability 144 of each respective candidate speech recognition hypothesis 142 to generate a corresponding rescored probability 164. That is, the LLM 160 does not generate any new candidate speech recognition hypotheses 142, but rescores the corresponding probabilities 144 generated by the ASR model 150. The LLM 160 may include a transformer architecture. For instance, in some implementations, the LLM 160 includes the Pathway Language Model 2 (PaLM 2) that uses a 256 k wordpiece vocabulary for tokenization and a transformer input dimension of 1536. The LLM 160 is trained on multilingual training data including web documents and books.

In some examples, the ASR model 150 generates the corresponding probability 144 for each respective candidate speech recognition hypothesis 142 based on an acoustic similarity between the candidate speech recognition hypothesis 142 and the corresponding acoustic frames 110. On the other hand, the LLM 160 generates the corresponding rescored probabilities 164 based on linguistic information (i.e., semantic interpretation) of the candidate speech recognition hypothesis 142. That is, since the ASR model 150 generates the multiple candidate speech recognition hypotheses 142 non-autoregressively and does not consider context of prior or subsequent acoustic frames, some of the candidate speech recognition hypotheses 142 may be acoustically similar to the spoken speech but linguistically have a low likelihood of accuracy. For example, the ASR model 150 may not be able to disambiguate between candidate speech recognition hypotheses 142 of “I have for dogs” and “I have four dogs” because of the non-autoregressive operation of the ASR model 150. Yet, in this example, the LLM 160 may be able to determine that the candidate speech recognition hypothesis 142 of “I have four dogs” has a greater likelihood of being accurate based on semantic interpretation.

To that end, the LLM 160 is configured to receive, as input, each respective candidate speech recognition hypothesis 142 and the corresponding probabilities 144 from the ASR model 150 and a previously generated transcription 121 corresponding to N prior audio segments 111. For example, the LLM 160 may receive 16 candidate speech recognition hypotheses 142 and the corresponding 16 probabilities 144 generated by the ASR model 150 for a respective audio segment 111 and a previously generated transcription 121 corresponding to 2 (e.g., N=2) prior audio segments 111 that immediately precede the respective audio segment 111. The LLM 160 concatenates each respective candidate speech recognition hypothesis 142 from the multiple candidate speech recognition hypotheses 142 with the previously generated transcription 121 to generate a concatenation 162 for each respective candidate speech recognition hypothesis 142. In particular, the LLM 160 may prepend the previously generated transcription 121 to each respective candidate speech recognition hypothesis 142 to generate the corresponding concatenation 162 for each respective candidate speech recognition hypothesis 142. Thereafter, the LLM 160 rescores the corresponding probability 144 of each respective candidate speech recognition hypothesis 142 based on the concatenation 162 of the respective candidate speech recognition hypothesis 142 and the previously generated transcription 121 to generate the corresponding rescored probability 164. The LLM 160 may generate the corresponding rescored probability 164 by rescoring the corresponding probability 144 of each respective candidate speech recognition hypothesis 142 non-autoregressively. In some implementations, the rescored probabilities 164 represent new probabilities that are not dependent upon the corresponding probabilities 144 generated by the ASR model 150.

In some implementations, the output layer 170 is configured to generate the transcription 120 for each audio segment 111 by selecting a respective one of the candidate speech recognition hypotheses 142 having a highest rescored probability 164 as the transcription 120. The output layer 170 may be independent from the ASR model 150 or integrated with the ASR model 150. In other implementations, the output layer 170 is configured to generate the transcription 120 for each audio segment 111 by selecting a respective one of the candidate speech recognition hypotheses 142 based on a combined probability including the corresponding probability 144 generated by the ASR model 150 and the rescored probability generated by the LLM 160. For instance, the output layer 170 may determine the combined probability according to:

$$log {p}_{final} ( y \vert x ) = log {p}_{asr} ( y \vert x ) + λ \cdot log {p}_{lm} ( y ) \qquad ( 1 )$$

In Equation 1, log p_{final}(y|x) represents the combined probability for a particular audio segment 111, log pₐₛᵣ(y|x) represents the corresponding probabilities 144 generated by the ASR model 150, log pᵢₘ (y) represents the corresponding rescored probabilities 164 generated by the LLM 160, and λ an LLM scoring weight. In some examples, the LLM scoring weight is equal to 0.3, however, the scoring weight can be any value.

As described above, the ASR system 200 operates in a streaming fashion by generating a corresponding transcription 120 at each of the plurality of output steps. Here, each output step corresponds to a respective one of the audio segments 111. Thus, if the audio segments 111 include 8 seconds of audio, the ASR system 200 produces a corresponding transcription 120 every 8 seconds. Advantageously, the ASR system 200 operates non-autoregressively (in contrast to autoregressive architectures such as RNN-T) to increase parallelization of inference thereby reducing latency. Moreover, because the CTC decoder does not retain decoder states, the ASR system 200 is more robust to premature segmentation (e.g., word truncation). Another advantage of the ASR system 200 is that it operates on a per-segment basis (instead of a per-frame basis (i.e., shallow fusion)) such that the ASR system 200 makes a number of propagations equal to the number of tokens of the LLM 160 multiplied by a number of hypotheses output by the ASR model 150 at each output step. In contrast, per-frame scoring requires a number of propagations equal to the number of acoustic frames multiplied by the number of hypotheses output by the ASR model 150 at each output step. Consequently, per-frame scoring requires an additional number of propagations equal to the number of acoustic frames divided by the number of tokens of the LLM 160 compared to per-segment scoring.

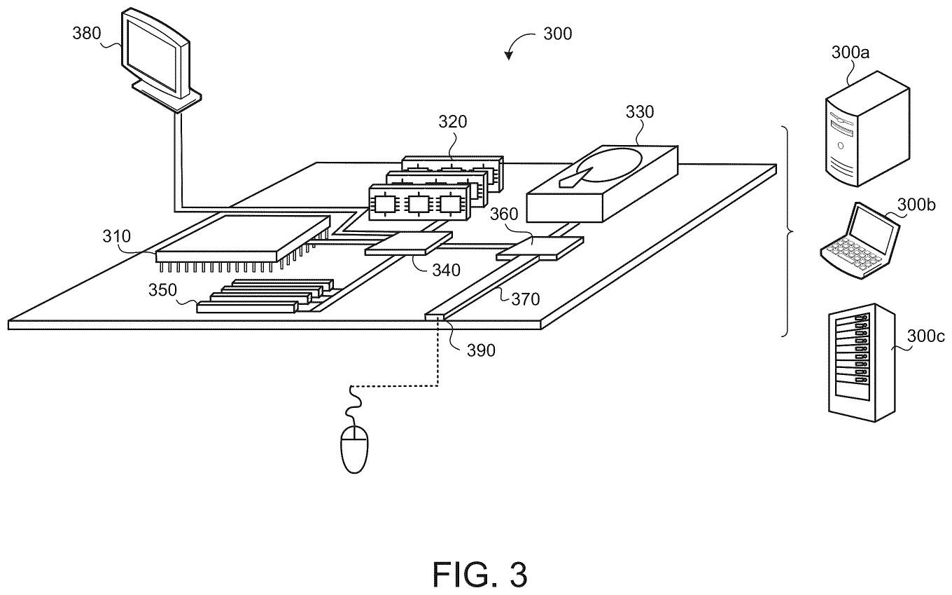

FIG. 3 is a schematic view of an example computing device 300 that may be used to implement the systems and methods described in this document. The computing device 300 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 300 includes a processor 310, memory 320, a storage device 330, a high-speed interface/controller 340 connecting to the memory 320 and high-speed expansion ports 350, and a low speed interface/controller 360 connecting to a low speed bus 370 and a storage device 330. Each of the components 310, 320, 330, 340, 350, and 360, are interconnected using various busses, and may be mounted on a common motherboard or in other manners as appropriate. The processor 310 (e.g., data processing hardware 113 of the user device 102 or data processing hardware of the remote system 60) can process instructions for execution within the computing device 300, including instructions stored in the memory 320 or on the storage device 330 to display graphical information for a graphical user interface (GUI) on an external input/output device, such as display 380 coupled to high speed interface 340. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 320 (e.g., memory hardware 113 of the user device 102 or memory hardware of the remote system 60) stores information non-transitorily within the computing device 300. The memory 320 may be a computer-readable medium, a volatile memory unit(s), or non-volatile memory unit(s). The non-transitory memory 320 may be physical devices used to store programs (e.g., sequences of instructions) or data (e.g., program state information) on a temporary or permanent basis for use by the computing device 300. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 330 is capable of providing mass storage for the computing device 300. In some implementations, the storage device 330 is a computer-readable medium. In various different implementations, the storage device 330 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 320, the storage device 330, or memory on processor 310.

The high speed controller 340 manages bandwidth-intensive operations for the computing device 300, while the low speed controller 360 manages lower bandwidth-intensive operations. Such allocation of duties is exemplary only. In some implementations, the high-speed controller 340 is coupled to the memory 320, the display 380 (e.g., through a graphics processor or accelerator), and to the high-speed expansion ports 350, which may accept various expansion cards (not shown). In some implementations, the low-speed controller 360 is coupled to the storage device 330 and a low-speed expansion port 390. The low-speed expansion port 390, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 300a or multiple times in a group of such servers 300a, as a laptop computer 300b, or as part of a rack server system 300c.

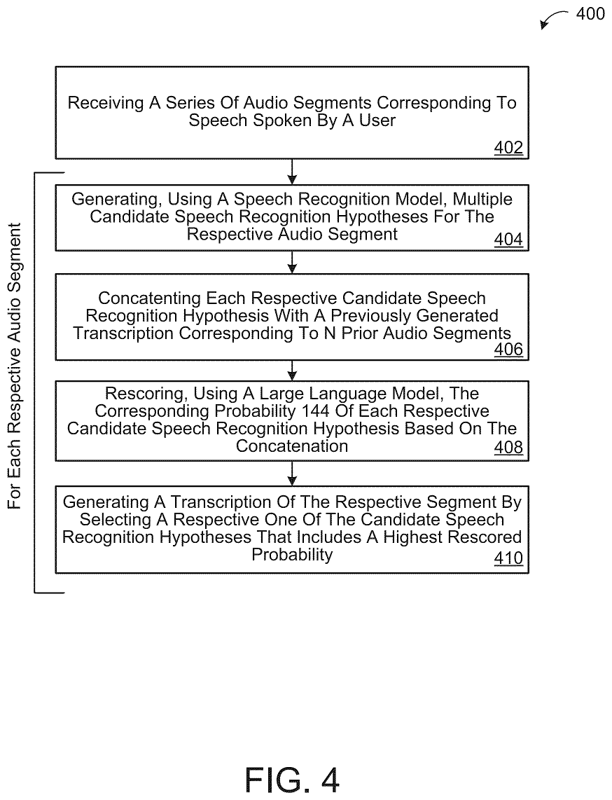

FIG. 4 is a flowchart of an exemplary arrangement of operations for a computer-implemented method 400 of using non-autoregressive and multilingual language models for rescoring speech recognition results output from a non-autoregressive speech recognition model. The operations may be performed by data processing hardware 310 (FIG. 3) (e.g., the data processing hardware 11 of the user device 10 or the data processing hardware of the remote computing system 60) based on executing instructions stored on memory hardware 320 (e.g., the memory hardware 13 of the user device 10 or the memory hardware of the remote computing system) in communication with the data processing hardware 310.

At operation 402, the method 400 includes receiving a series of audio segments 111 corresponding to speech spoken by a user 104. Operations 404-410 are performed for each respective audio segment 111 in the series of audio segments 111.

At operation 404, the method 400 includes generating, using a speech recognition model 150, multiple candidate speech recognition hypotheses 142 for the respective audio segment 11. Here, each respective candidate speech recognition hypothesis 142 includes a corresponding probability 144. At operation 406, the method 400 includes concatenating each respective candidate speech recognition hypothesis 142 from the multiple candidate speech recognition hypotheses 142 with a previously generated transcription 121 corresponding to N prior audio segments 111.

At operation 408, the method 400 includes rescoring, using a large language model (LLM) 160, the corresponding probability 144 of each respective candidate speech recognition hypothesis 142 based on the concatenation 162 of the respective candidate speech recognition hypothesis 142 and the previously generated transcription 121. At operation 410, the method 400 includes generating a transcription 120 of the respective speech segment 111 by selecting a respective one of the candidate speech recognition hypotheses 142 that includes a highest rescored probability 164.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
receiving a series of audio segments corresponding to speech spoken by a user; and
for each respective audio segment in the series of audio segments:
generating, using a speech recognition model, multiple candidate speech recognition hypotheses for the respective audio segment, each respective candidate speech recognition hypothesis comprising a corresponding probability:
concatenating each respective candidate speech recognition hypothesis from the multiple candidate speech recognition hypotheses with a previously generated transcription corresponding to N prior audio segments;
rescoring, using a large language model (LLM), the corresponding probability of each respective candidate speech recognition hypothesis based on the concatenation of the respective candidate speech recognition hypothesis and the previously generated transcription; and
generating a transcription of the respective speech segment by selecting a respective one of the candidate speech recognition hypotheses comprising a highest rescored probability.

2. The computer-implemented method of claim 1, wherein the speech recognition model comprises an encoder and a decoder.

3. The computer-implemented method of claim 2, wherein the encoder generates a higher order feature representation for each respective audio segment by applying chunk-wise bi-directional attention.

4. The computer-implemented method of claim 2, wherein the encoder comprises a stack of multi-headed attention layers each including a multi-headed self-attention mechanism.

5. The computer-implemented method of claim 4, wherein the stack of multi-headed attention layers comprises a stack of conformer layers.

6. The computer-implemented method of claim 5, wherein the stack of conformer layers comprises a stack of 32 layers having about two billion parameters.

7. The computer-implemented method of claim 2, wherein the decoder comprises a Connectionist Temporal Classification (CTC) decoder.

8. The computer-implemented method of claim 2, wherein:
the decoder generates the multiple candidate speech recognition hypotheses non-autoregressively; and
the LLM rescores the corresponding probability of each respective candidate speech recognition hypothesis non-autoregressively.

9. The computer-implemented method of claim 1, wherein the speech spoken by the user comprises a long-form utterance.

10. The computer-implemented method of claim 1, wherein the N prior audio segments immediately precede the respective audio segment.

11. A system comprising:
data processing hardware; and
memory hardware in communication with the data processing hardware, the memory hardware storing instructions that when executed on the data processing hardware cause the data processing hardware to perform operations comprising:
receiving a series of audio segments corresponding to speech spoken by a user; and
for each respective audio segment in the series of audio segments:
generating, using a speech recognition model, multiple candidate speech recognition hypotheses for the respective audio segment, each respective candidate speech recognition hypothesis comprising a corresponding probability;
concatenating each respective candidate speech recognition hypothesis from the multiple candidate speech recognition hypotheses with a previously generated transcription corresponding to N prior audio segments;
rescoring, using a large language model (LLM), the corresponding probability of each respective candidate speech recognition hypothesis based on the concatenation of the respective candidate speech recognition hypothesis and the previously generated transcription; and
generating a transcription of the respective speech segment by selecting a respective one of the candidate speech recognition hypotheses comprising a highest rescored probability.

12. The system of claim 11, wherein the speech recognition model comprises an encoder and a decoder.

13. The system of claim 12, wherein the encoder generates a higher order feature representation for each respective audio segment by applying chunk-wise bi-directional attention.

14. The system of claim 12, wherein the encoder comprises a stack of multi-headed attention layers each including a multi-headed self-attention mechanism.

15. The system of claim 14, wherein the stack of multi-headed attention layers comprises a stack of conformer layers.

16. The system of claim 15, wherein the stack of conformer layers comprises a stack of 32 layers having about two billion parameters.

17. The system of claim 12, wherein the decoder comprises a Connectionist Temporal Classification (CTC) decoder.

18. The system of claim 12, wherein:
the decoder generates the multiple candidate speech recognition hypotheses non-autoregressively; and
the LLM rescores the corresponding probability of each respective candidate speech recognition hypothesis non-autoregressively.

19. The system of claim 11, wherein the speech spoken by the user comprises a long-form utterance.

20. The system of claim 11, wherein the N prior audio segments immediately precede the respective audio segment.
